(19) United States
(12) Patent Application Publication
(10) Pub. No.: US 2014/0026695 A1
(43) Pub. Date: Jan. 30, 2014

(54) Motion and Fundamental Frequency Doubling Planar and Spatial Linkage Mechanisms and Applications therefore

(71) Applicants: Jahangir S. Rastegar, Stony Brook, NY (US); Thomas Spinelli, Northport, NY (US)

(72) Inventors: Jahangir S. Rastegar, Stony Brook, NY (US); Thomas Spinelli, Northport, NY (US)

(73) Assignee: OMNITEK PARTNERS LLC, Ronkonkoma, NY (US)

(21) Appl. No.: 14/045,752

(22) Filed: Oct. 3, 2013

Related U.S. Application Data
(62) Division of application No. 10/932,580, filed on Sep. 2, 2004, now abandoned.
(60) Provisional application No. 60/499,444, filed on Sep. 2, 2003.

(51) Int. Cl. F16H 21/18

(52) U.S. Cl. CPC F16H 21/18
USPC 74/49

(57) ABSTRACT

A method for doubling an input motion of a first mechanism including: providing the first mechanism having a first link, a second link rotatably connected to the first link; a first output which undergoes a motion resulting from a motion of the first link, the first output being operatively connected to the first link through at least the second link; driving the first link from a first position to a second position, wherein a singular position of the first and second links occurs between the first and second positions; cascading the first mechanism with a second mechanism; and inputting the second mechanism with the output to double the output and quadruple the input.

### CROSS-REFERENCE TO RELATED APPLICATIONS

This application is a divisional application of U.S. patent application Ser. No. 10/932,580 filed on Sep. 2, 2004, which claims the benefit of earlier filed provisional patent application 60/499,444 filed Sep. 2, 2003, entitled “On The Existence Of Special Cases Of Input Speed Doubling Linkage Mechanisms,” the contents of each of which are incorporated herein by its reference.

### BACKGROUND OF THE INVENTION

1. Field of the Invention

The present invention relates generally to linkages, and more particularly, to frequency doubling planar and spatial linkage mechanisms.

2. Prior Art

A number of investigators have studied the harmonic content of closed-loop linkage mechanisms with rigid links and have developed direct analysis and synthesis methods based on the harmonic content of the output motion. It has been shown that if the motion of the input link of a linkage mechanism were periodic with a fundamental frequency ω, the output motion would also be a periodic motion with the same fundamental frequency ω. However, since linkage mechanisms commonly have a nonlinear input-output motion relationship, the output motion would also contain harmonics of the input motion harmonics. For example, if the input link of a four-bar or slider-crank linkage mechanism turns angular velocity of ω, or if it oscillates with a simple harmonic motion with a frequency ω, the output link would undergo a periodic motion with the fundamental frequency ω and a number of its harmonics. In only a few special cases, e.g., in four-bar parallelogram mechanisms, the input-output relationship is linear and therefore the output motion has the same number of harmonics as the input motion.

The fact that the input and the output motions have to have identical fundamental frequencies can also be explained from the fact that in general, during one cycle of input motion, the output has to complete its motion cycle, therefore should have the same fundamental frequency as the input. For example, in a four-bar crank-crank (crank-rocker) mechanism, one full turn of the input link can only result in one continuous turn (rocking motion) of the output link. In addition, since during one full turn of the input link the coupler and output link chain has to stay within one of their two configurations, the rocker can only make a single continuous back and forth motion between its two extreme positions. This is obviously also the case for rocking input link motion, i.e., if the input link undergoes one continuous back and forth motion, then output link undergoes one back and forth motion. This argument is obviously true for any linkage mechanism.

It can therefore be said that as it is known to date and in general, for a continuous full rotation or a continuous rocking motion of the input link of a linkage mechanism, the output link can only undergo a continuous rotation or a continuous rocking motion. The only exceptions that have been discovered to date are the Galloway type of mechanisms. In these crank-crank type of planar and spatial linkage mechanisms, two turns of the input link results in one full turn of the output link. It has been shown that such motions are possible only in certain special cases. In such cases, one full cycle of the input link rotation occurs in one configuration (branch) and the second cycle in a second configuration of the linkage chain that starts from the output link and extend to the moving joint of the input link. For example, in the Galloway (or deltoid) mechanism, during one full rotation of the input link, the open-loop output and coupler link chain is in one configuration, and during the second full turn of the input link, the chain is in its second configuration.

### SUMMARY OF THE INVENTION

Therefore, it is an objective of the present invention to overcome the deficiencies of the prior art mechanisms.

Accordingly, a mechanism is provided. The mechanism comprising: a first link; a second link rotatably connected to the first link; a first output which undergoes a motion resulting from a motion of the first link, the first output being operatively connected to the first link through at least the second link; and an input actuator for driving the first link from a first position to a second position, wherein a singular position of the first and second links occurs between the first and second positions.

The input actuator can drive the first link in a rocking motion. The input actuator can drive the first link in a full rotation motion.

The mechanism can further comprise a third link rotatable connected to the second link at one end and operatively connected to the first output at another end.

The input actuator can be a motor. The input actuator can be a link from another mechanism.

The mechanism can further comprise: a third link operatively connected to the first output; a fourth link rotatably connected to the third link; and a second output which undergoes a motion resulting from a motion of the third link, the second output being operatively connected to the third link through at least the fourth link; wherein the first output drives the third link from a third position to a fourth position, wherein a singular position of the third and fourth links occurs between the third and fourth positions.

The output can be configured to drive a shaker. The output can be configured to drive a mixer. The output can be configured to drive a crusher.

Also provide is a device comprising: a first member; a second member rotatable connected to the first member; an output which undergoes a motion resulting from a motion of the first member, the output being operatively connected to the first member through at least the second member; and an input actuator for driving the first member from a first position to a second position, wherein a singular position of the first and second members occurs between the first and second positions.

Still provided is a device comprising: a first member; a second member rotatable connected to the first member; an output which undergoes a motion resulting from a motion of the first member, the output being operatively connected to the first member through at least the second member; and an input actuator for driving the first member through a range of motion which includes a singular position of the first and second members.

Still further provided is a device for suppressing an input motion. The device comprising: an input which undergoes a motion; an output at which the motion is suppressed; a first linkage operatively connecting the input and output, the first linkage comprising a first link rotatably connected to the output at a first portion and a second link rotatably connected to a second portion of the first link at a third portion and to a damper at a fourth portion, the damper being operatively connected to the input; wherein the first and second links are driven through their singular position by the motion.

The device can be a suspension of a vehicle, where the input is one or more wheels of the vehicle and the output is a chassis of the vehicle.

The device can further comprise: a second linkage operatively connecting the input and output, the second linkage comprising a third link rotatably connected to the output at a fifth portion and a fourth link rotatably connected to a sixth portion of the third link at a seventh portion and to a damper at a eighth portion, the damper being operatively connected to the input; wherein the first, second, third and fourth links are driven through their singular position by the motion.

Still further provided is a method for doubling an input motion of a first mechanism. The method comprising: providing the first mechanism having a first link, a second link rotatably connected to the first link; a first output which undergoes a motion resulting from a motion of the first link, the first output being operatively connected to the first link through at least the second link; and driving the first link from a first position to a second position, wherein a singular position of the first and second links occurs between the first and second positions.

The method can further comprise: cascading the first mechanism with a second mechanism; and inputting the second mechanism with the output to double the output and quadruple the input.

Still yet provided is a method for doubling an input motion of a first mechanism. The method comprising: providing the first mechanism having a first link, a second link rotatably connected to the first link; a first output which undergoes a motion resulting from a motion of the first link, the first output being operatively connected to the first link through at least the second link; and driving the first link through a range of motion which includes a singular position of the first and second members.

The method can further comprise: cascading the first mechanism with a second mechanism; and inputting the second mechanism with the output to double the output and quadruple the input.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematic of a slider-crank linkage mechanism having an input motion as is known in the prior art.

FIG. 2 illustrates a schematic of an embodiment of a slider-crank linkage mechanism of the present invention.

FIG. 3 illustrates an embodiment of a schematic of a four-bar linkage mechanism of the present invention.

FIG. 4 illustrates an embodiment of a schematic of a crank-rocker type of mechanism of the present invention.

FIG. 5 illustrates an embodiment of a schematic of the output of the mechanism of FIG. 4 used as an input to a second motion-doubling mechanism.

FIG. 6 illustrates a plot of the input and the resulting motion and fundamental frequency-doubled output motion for an example of the mechanism of FIG. 3.

FIG. 7 illustrates a schematic of an embodiment of an isolation system of the present invention.

### DETAILED DESCRIPTION OF THE PREFERRED EMBODIMENT

The present invention discloses special classes of planar and spatial linkage mechanisms in which for a continuous full rotation or continuous rocking motion of the input link, the output link undergoes two continuous rocking motions. Such mechanisms are hereinafter referred to as “motion-doubling” linkage mechanisms.

In a special case of such mechanisms, for periodic motions of the input link with a fundamental frequency ω, the output motion is periodic but with a fundamental frequency of 2ω. This mechanism is hereinafter referred to as the “fundamental frequency-doubling” linkage mechanism.

The motion-doubling linkage mechanisms can be cascaded to provide further doubling of the output rocking motion. Such mechanisms may be cascaded with other appropriate linkage mechanisms to obtain crank-rocker or crank-crank type of mechanisms. Furthermore, a doubling of a full rotation or rocking motion into a rocking motion can be converted into a full rotation (which is doubled) by use of a piston/crankshaft arrangement (where the output rocker is the piston which turns a crankshaft). Such piston/crankshaft arrangements for converting a rocking motion (an oscillation) into a rotating motion are well known in the art.

In addition, a special class of linkage mechanisms is presented in which for a full continuous rocking motion of the input link, the coupler link undergoes two continuous rocking motions. Such mechanisms are referred to as coupler motion-doubling linkage mechanisms. Similarly, the output rocking motion can be converted to a full rotation motion, such as with a piston/crankshaft arrangement.

Such motion-doubling mechanisms have practical applications, particularly when higher output or coupler speeds are desired, since higher output or coupler motions can be achieved with lower input speeds.

In addition, such mechanisms also generally have force transmission and dynamics advantages over regular mechanisms designed that could be used to achieve similar output or coupler speeds, in the sense that their links and joints are subject to lower dynamics forces and can therefore be designed with lighter weight components and are subject to less vibration related problems. In addition, with by reducing the dynamics forces and the mass of the various components of the linkage mechanism, the actuating motor that is required to drive the mechanism becomes smaller and its dynamics response requirement is greatly reduced, which almost always translates into less expensive and lighter weight actuating motors.

The conditions for the existence of output and coupler motion-doubling linkage mechanisms and fundamental frequency-doubling linkage mechanisms are and their mode of operation is described below.

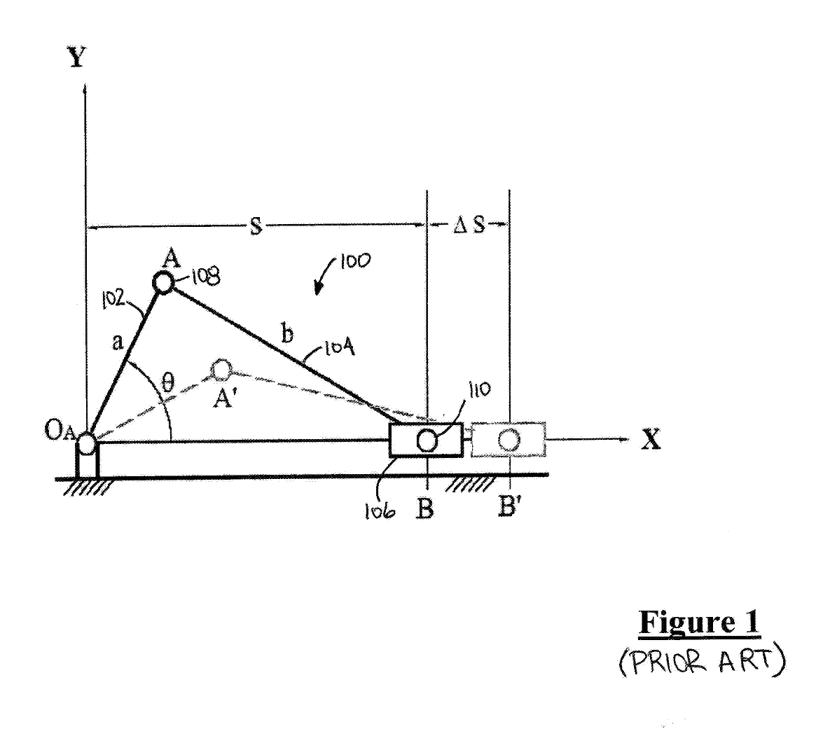

Consider the slider-crank linkage mechanism shown in FIG. 1. The input link 102 with the length a makes an angle θ with the X-axis of the fixed XY coordinate system. The input at O_{A} can be any input known in the art, generally referred to as an actuator 101, such as a motor. The coupler link 104 has a length b. The position of the slider block 106 along the X-axis is shown by s. If the input link 102 at position O_{A}A undergoes a periodic motion with a fundamental frequency ω, e.g., if the motion of the input is the simple harmonic motion

θ=θ₀+θ₁ sin(ωt) (1)

where θ₁ is the amplitude of the input link oscillation about the position θ₀. The output motion s is periodic with the same fundamental frequency ω, and a certain number of its harmonics with significant amplitudes, i.e.

$$s = {s}_{0} + {\sum }_{i = 1}^{n} {s}_{i} sin ( iω t + {φ}_{i} ) \qquad ( 2 )$$

where n is the number of harmonics with significant amplitudes, s₀ is a constant, and sᵢ, i=0, 1, . . . , n is the constant amplitude and φᵢ is the phase of the ith harmonic of the output motion.

The links 102, 104 can be of any structural configuration known in the art. Furthermore, the connection between the links 102, 104 as well as the connection between the coupler link 104 and the slider block 106 are pivoting (rotating) joints 108, 110 as are known in the art. The slider block 106 can be a mass or a portion of the coupler link 104, which is confined along the x-axis. As discussed below, the output can also be associated with another device, another linkage, a bracket for holding an object (e.g., a paint can), or an end effector (e.g., a tool for crushing solid objects).

Let a cycle of the harmonic motion (1) of the input link 102 start from the position O_{A}A (solid lines), continue to the position O_{A}A′ (dashed lines) during the first half of the cycle of motion, and bring the input link back to its starting position O_{A}A during the second half of the cycle of motion. During this motion, the output slider block 106 moves from its starting position B to the position B′ during the first half of the cycle of motion, and moves back to the position B during the second half of the cycle of motion, i.e., during each cycle of motion, the output slider block 106 undergoes one cycle of back and forth motion.

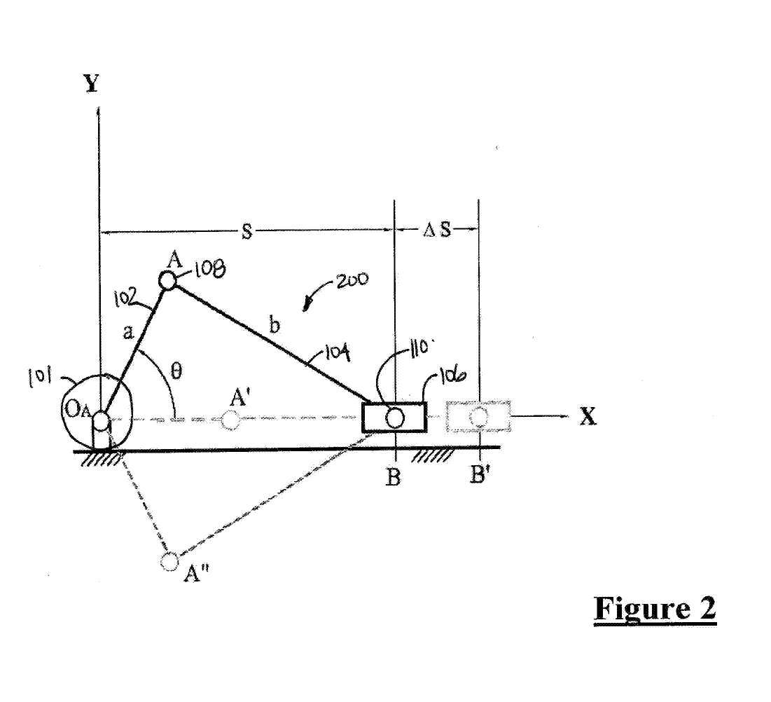

Referring now to FIG. 2, a linkage 200 is illustrated therein similar in construction to that shown in FIG. 1 but driven by an input actuator in a different manner to achieve a different and novel result at the output thereof. Consider the case in which the harmonic motion (1) of the input link 102 starts from the position O_{A}A (solid lines), FIG. 2, continues to the position O_{A}A″ (dotted lines), which is symmetrically positioned with respect to the X axis, during the first half of the cycle of motion, and brings the input link 102 back to its starting position O_{A}A during the second half of the cycle of motion. During this motion, the output slider block 106 moves from the position B to the position B′ as the input link 102 moves from the position O_{A}A to the position O_{A}A′, where the input link 102 and the coupler link 104 are collinear, i.e., are in their singular position. As the input link 102 motion continues from the position O_{A}A′ to the position O_{A}A″, the output slider block 106 moves back to its starting position B. The back and forth motion of the output slider block 106 is repeated as the input link 102 rotates back from its O_{A}A″ position to its starting position O_{A}A. Thus, during one back and forth cycle of the input link 102 motion, the output slider block 106 undergoes two back and forth motions. In this special case of symmetrical motion of the input link 102 about the singular position of the input link 102 and coupler link 104, the two back and forth motions of the output slider block 106 are identical, each constituting a simple harmonic motion with the fundamental frequency 2ω. The motion of the output slider block 106, equation (2), is thereby reduced to

$$s = {s}_{0} + {\sum }_{i = 1}^{m} {s}_{i} sin ( 2 i ω t + {φ}_{i} ) \qquad ( 3 )$$

where m is the number of harmonics with significant amplitudes.

The output motion is therefore doubled, i.e., the output motion is periodic and its fundamental frequency has been doubled. It can also be said that one back and forth motion of the input link 102 results in two back and forth motion of the output slider block 106. The above motion doubling occurs for all input motions as long as the motion during both forward and return half cycles of the input link 102 motion are identical except in their direction. As discussed above, the rocking output motion can be converted to a full rotation motion, such as with the use of a piston/crankshaft arrangement as is known in the art.

In the general case of non-symmetrical motion of the input link 102 about its singular (θ=0) position, the two back and forth motions of the output slider block 106 are not identical, and the motion of the output slider block 106 is still described by equation (2), i.e., the fundamental frequency of the output motion is still ω and is not doubled. However, during one back and forth cycle of input link 102 motion, the output slider block 106 still undergoes two back and forth motions, i.e., the output motion is doubled.

The reason why two back and forth motions of the output slider block 106 can be achieved for each single back and forth motion of the input link 102 is as follows. The input link 102 and coupler link 104 chain can place the output slider block 106 in a specified position s within their reachable space with two different configurations or branches, noting such configurations or branches always have to appear in pairs. When the back and forth motion of the input link 102 is only one of the two configurations of the chain (FIG. 1), the output slider block 106 can only undergo one back and forth motion, since the functions describing such motions are one to one. Thus, the only way that a single back and forth motion of the input link 102 could result in two back and forth motions of the output slider block 106 is when one of the latter motions occurs in one configuration and the second motion in the other configuration of the input link 102 and coupler link 104 chain as is shown in FIG. 2.

In general, the two back and forth motions of the output slider block 106 are not identical, and together constitute one cycle of a periodic function with the fundamental frequency ω of the input motion as described by equation (2). However, when the input motion is symmetrical with respect to the singular position of the input link 102 and the coupler link 104 chain, the two back and forth motions of the output slider block 106 become identical, each constituting a simple harmonic motion with the fundamental frequency 2ω, as described by equation (3).

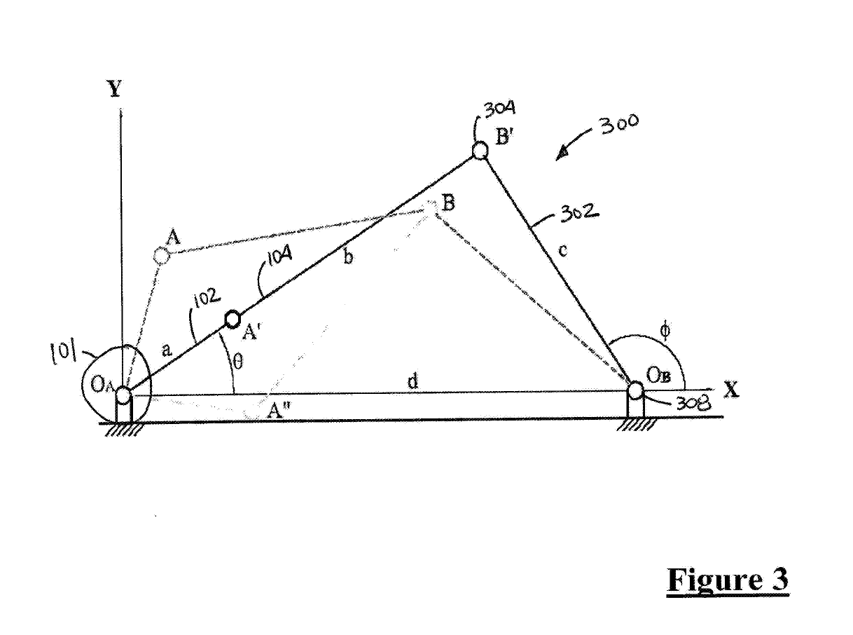

Similar input motion doubling occurs in all linkage mechanisms when the input link crosses its singular position with the next (coupler like) link during its back and forth (rocking) motion. As a result, the output link undergoes one “back and forth” (rocking) motion in one configuration and a second rocking motion in the other configuration of the input and coupler link chain. For example, such a motion is illustrated in FIG. 3 for a four-bar linkage mechanism 300 in which a second coupler link (or output link) 302 is pivotally coupled with the first coupler link 104 at pivot joint 304 at one end and pivotally coupled with an output at pivot joint 308. Any output device (including another linkage mechanism) known in the art can be coupled to the pivot joint 308 (output).

Here, during one cycle of the input link 102 motion, the input link 102 starts its motion from the position OA, pass through the singular position of the input link 102 and coupler link 104 OA′ and up to the position OA″, and continuously returns to its starting position OA. Similarly, if the two rocking motions of the output link 302 are identical, the fundamental frequency of the output link 302 motion is doubled. The two rocking motions of the output link 302 are identical when the motion of the input link 102 in each of the two configurations of the input link 102 and coupler link 104 chain are identical, i.e., the motion from the position OA′ to the position OA and back is identical to the motion from the position OA′ to the position OA″ and back.

In the above two examples illustrated in FIGS. 2 and 3, the input link 102 undergoes one rocking motion, crossing the singular position of the input link 102 and coupler link 104 chains during its motion. Such singular position crossings are essential to allow for one rocking motion of the output in one configuration of the input link 102 and coupler link 104 chain and another in the other configuration of the input link 102 and coupler link 104 chain. Such a pattern of singular position crossings is obviously not possible if the input link 102 undergoes a full and continuous rotation, i.e., by crank-rocker or crank-crank type of linkage mechanisms.

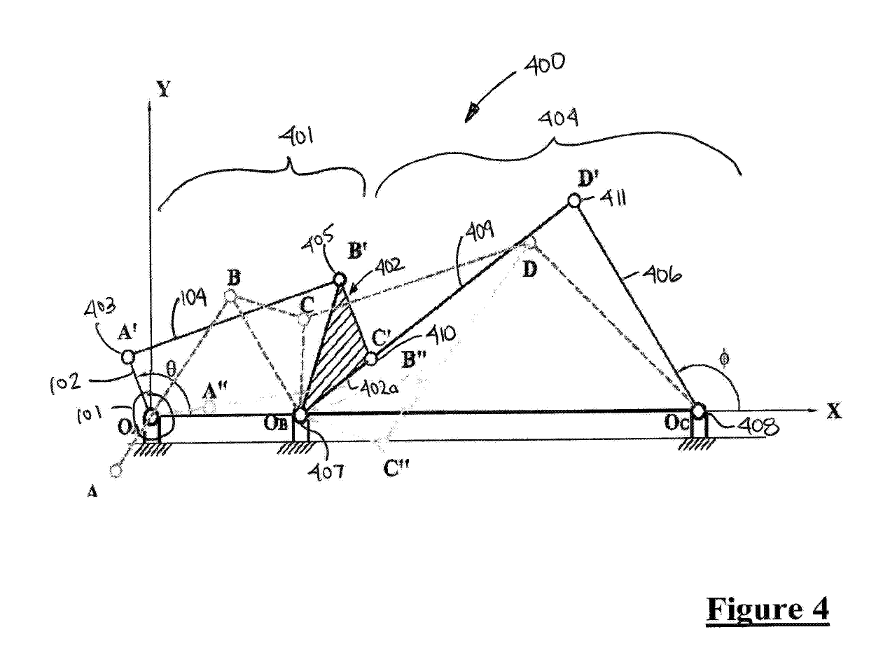

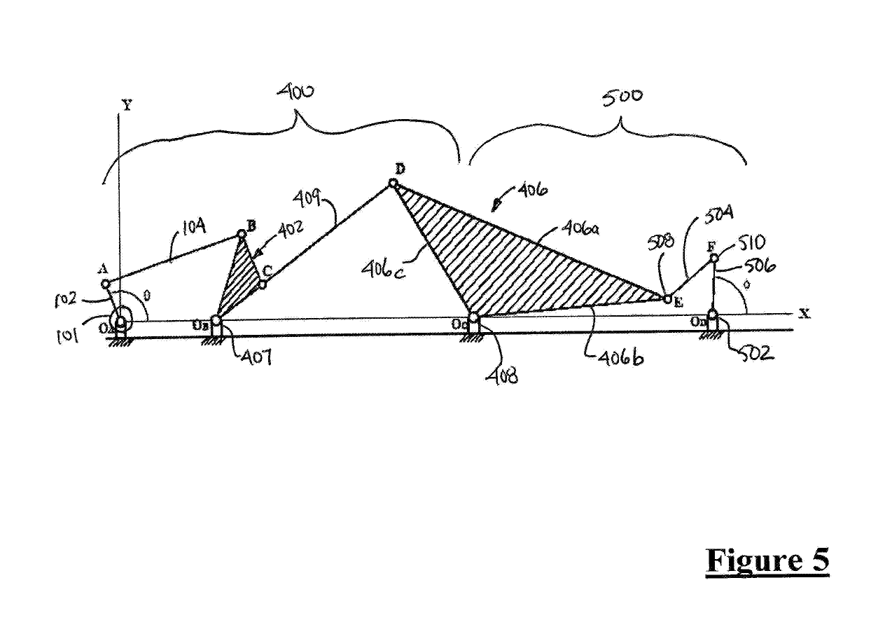

The aforementioned rocking motion of the input link may be, however, generated by another crank-rocker type of mechanism, such as the one shown in FIG. 4. In the mechanism 400 of FIG. 4, a first linkage 401 consists of links 102, 104, and 402 coupled by rotating joints 403 and 405. An input actuator 101 drives the input link 102 through a full rotation which results in a rocking motion output at pivoting joint 407. Link 402 is a three-sided member that serves as an input to a second linkage 404. The second linkage includes a first link 402a, which is a portion of link 402 of the first linkage. Link 402a is rotatably coupled to link 409 through joint 410. Link 409 is rotatably coupled to an output link 406 through joint 411 at one end. Another end of output link 406 is rotatably coupled to an output at 408. As shown in FIG. 5, the output of the first mechanism 401 drives the input of the second mechanism 404 through a singular position (shown in solid lines) of link 402a and link 409. Therefore, the output at 408 of the second mechanism is doubled as discussed above. Thus, the combined mechanism 400 of FIG. 5 is input with a full rotation motion at link 102 and outputs with a rocking motion at 408 having a doubled frequency.

As shown in FIG. 5, motion-doubling mechanisms may be cascaded to quadruple the input motion. For example, the output of the mechanism 400 shown in FIG. 4 may be used as an input to a second motion-doubling mechanism 500 to further double the input motion at link 102 to obtain a quadrupled output motion at 502. Mechanism 400 is used to input mechanism 500 which consists of linkage 406 (which now consists of a three-sided linkage member having sides 406a-c). Linkage member 406 is rotatably connected to links 504 and 506 through pivoting joints 508 and 510. When links 406b and 504 are driven through their singular position, the output at 502 is doubled with regard to the in put at 408 (which is doubled with regard to input 407) resulting in a net effect of quadrupling the input.

This process of motion doubling may continue to further double the output motion, and in theory there is no limit to this doubling process, but in practice, the output motion generally keeps getting smaller by each motion doubling process.

An example is provided next for a motion and fundamental frequency-doubling four-bar linkage mechanism. Consider the four-bar linkage mechanism shown in FIG. 3. Let the link lengths be a=3.5 cm, b=6.5 cm, c=7.5 cm and d=12 cm. The input motion is considered to be a simple harmonic motion given by

θ=θ₀+30 cos(ωt) (4)

where θ₀ is the input angle at the singular position of the input and coupler links and ω is the fundamental frequency of the input motion.

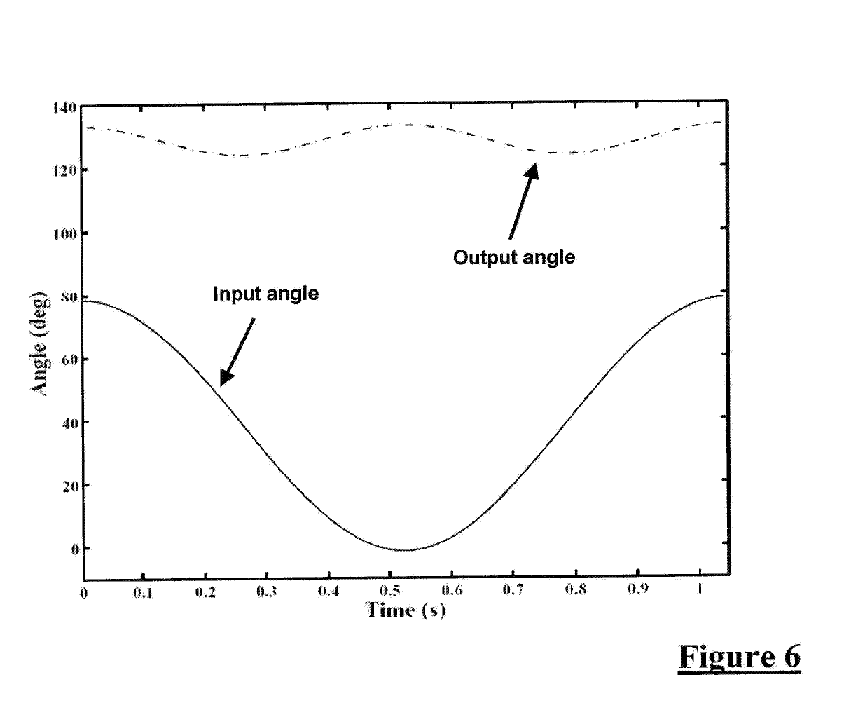

With the aforementioned link lengths, the angle θ₀ is readily determined to be 38.52 deg. Since the input motion, equation (4), is symmetric about the singular position of the input and coupler link chain, the fundamental frequency of the output motion is doubled and the output link undergoes two rocking motions during each cycle of the input motion. For a fundamental frequency of ω=6 rad/sec, the plot of the input and the resulting motion and fundamental frequency-doubled output motion are shown in FIG. 6.

The disclosed motion and fundamental frequency doubling plane and spatial linkage mechanisms may be coupled to other mechanisms to achieve the desired higher speed motions with slower input actuator (e.g., a motor). The disclosed classes of mechanisms have a wide range of applications, particularly in higher speed machinery and devices where dynamics and vibration become problematic, limit the performance, or make the machinery or device expensive and/or heavy. The following are a number of specific applications for which the disclosed motion and fundamental frequency doubling mechanisms are of significant advantage.

In a first example, the output link motion is doubled, preferably with the doubled fundamental frequency also doubled. The output motion is then used to drive a shaker (used for example, for sorting, sieving, staining, or the like), a mixer (used for example, for mixing paint, chemicals, various fluids, or other types of materials), or a crusher (such as machinery used to crush various solid materials).

In another example, the motion of a coupler link of the mechanism is doubled. The output motion is then used to drive a shaker (used for example, for sorting, sieving, staining, or the like), a mixer (used for example, for mixing paint, chemicals, various fluids, or other types of materials, or a crusher (such as machinery used to crush various solid materials).

In yet another example, the motion-doubling characteristic of the mechanisms of the present invention may be used to construct shock and vibration isolation and suspension systems. For example, passive suspension mechanisms may be constructed in which dampers (or spring-damper units) undergo two cycles for each cycle of input oscillation. Such passive suspensions can also be designed to provide one cycle of damper (or damper-spring units) undergo one cycle of output motion with each cycle of input oscillation when the amplitude of the output oscillation is small. The dampers (or spring-damper units) then undergo two cycles of oscillations when the amplitude of the output oscillation becomes large. The latter mechanisms have the advantage of providing “soft” suspensions as long as the amplitude of the resulting oscillation is small. However, if the amplitude of oscillation becomes large, they would rapidly reduce the amplitude of oscillation by doubling the motion of the dampers (or spring-damper units).

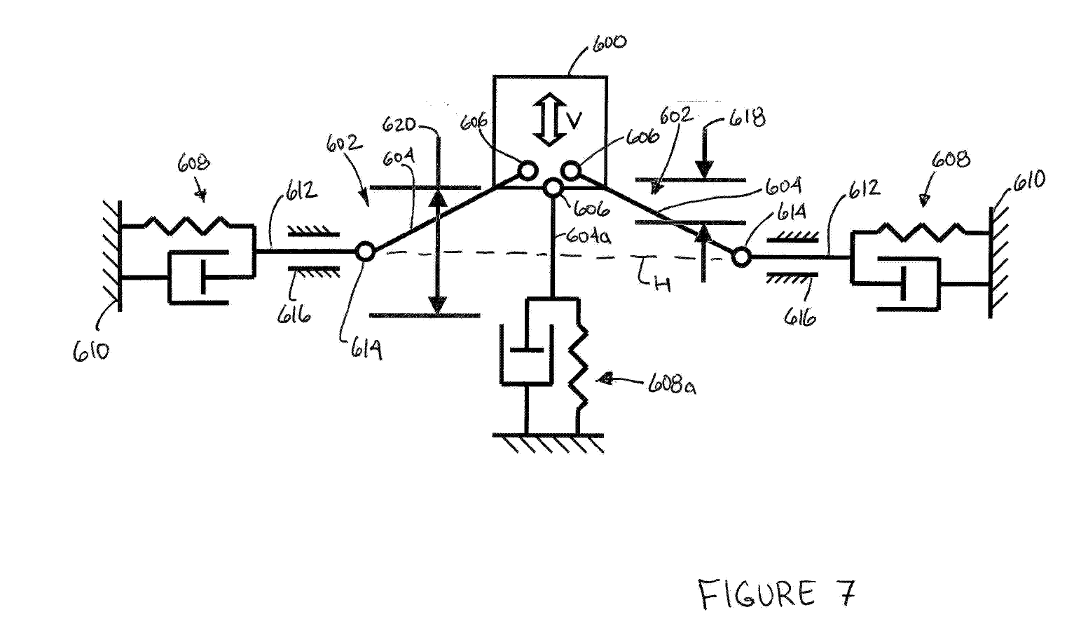

The schematic of such an isolation mechanism, as used to isolate an oscillating device is shown in FIG. 7. Such an isolation system can also be used as a car suspension, in which case, the mechanism is positioned between each wheel axle and the chassis.

In FIG. 7, an oscillating mass 600 with its direction of oscillation is shown. Here two motion-doubling mechanisms 602 (each consisting of a first link 604, connected to the oscillating mass 600 by a pivoting joint 606 on one end and to a second link 612 on the other end) are used. The first link 604 is connected to the second link 612 by a pivoting joint 614 on one end and to a horizontal spring-damper unit 608 on another end. In the example of FIG. 7, the second link 612 is confined to slide in the horizontal direction by collar 616. The input disturbances are considered to coming from the ground 610 (or base). If the resulting amplitude of oscillation of the mass 600 is small, i.e., during its oscillation, the first and second links 604, 612 do not line up along the horizontal line (H) (their singular position), such as the amplitude 618. In this case, during each oscillation of the mass 600, the spring and damper units 608 (including unit 608a discussed below) undergo one cycle of (back and forth) motion. When the amplitude of oscillation of the mass 600 becomes large, i.e., when during one cycle of oscillation the first and second links 604, 612 pass through their singular position, such as the amplitude 620, then the horizontally positioned spring and damper units 608 undergo two cycles of back and forth motion. As a result, a significantly larger amount of energy is taken out of the system, thereby the oscillations of the mass 600 is reduced (damped) at significantly higher rates. It is noticed that such a significant change in the rate of damping is achieved in a totally passive and automatic manner as the amplitude of oscillation is increased beyond a desired level (as defined by the rest or initial angular position of the links). Another advantage of such shock or vibration isolation or suspension mechanisms is that the spring and damper units 608 attached to the links generate essentially symmetrical loads on the support structure (shown as ground 610 in FIG. 7), thereby making it easier to support as internal forces with minimal dynamics implications.

A further spring and damper unit 608a can be added in the vertical direction and coupled to the mass 600 by a vertical link 604a to further stabilize the system. As discussed above, the ground (or the wheel of an automobile) 610 can serve as an input to the system where the output is a damped mass 600 (which can be the chassis of the automobile), however, the mass 600 can also serve as the input to the system where the output is at the ground (e.g., for damping the vibrations of a machine).

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for doubling an input motion of a first mechanism, the method comprising:
providing the first mechanism having a first link, a second link rotatably connected to the first link; a first output which undergoes a motion resulting from a motion of the first link, the first output being operatively connected to the first link through at least the second link;
driving the first link from a first position to a second position, wherein a singular position of the first and second links occurs between the first and second positions;
cascading the first mechanism with a second mechanism; and
inputting the second mechanism with the output to double the output and quadruple the input.

2. A method for doubling an input motion of a first mechanism, the method comprising:
providing the first mechanism having a first link, a second link rotatably connected to the first link; a first output which undergoes a motion resulting from a motion of the first link, the first output being operatively connected to the first link through at least the second link;
driving the first link through a range of motion which includes a singular position of the first and second members;
cascading the first mechanism with a second mechanism; and
inputting the second mechanism with the output to double the output and quadruple the input.
